(19) United States
(12) Patent Application Publication
(10) Pub. No.: US 2025/0162632 A1
(43) Pub. Date: May 22, 2025

(54) VEHICLE LUGGAGE BOARD TO BE USED AS CART

(71) Applicant: DAEHAN SOLUTION CO., LTD., Incheon, (KR)

(72) Inventors: CHOONG HO KWON, SEOUL (KR); DAEHEE PARK, INCHEON (KR)

(21) Appl. No.: 18/910,206

(22) Filed: Oct. 9, 2024

(30) Foreign Application Priority Data
Nov. 20, 2023 (KR) 10-2023-0161068

(51) Int. Cl. B62B 3/02; B60R 13/01; B62B 3/00; B62B 5/06

(52) U.S. Cl. CPC B62B 3/022; B60R 13/013; B62B 3/002; B62B 5/067; B62B 2205/20

(57) ABSTRACT

The present invention is directed to providing a vehicle luggage board to be used as a cart in which a luggage board provided as a basic component in a vehicle and installed on a floor of a trunk is used and is transformed into and used as a cart as necessary, by taking the luggage board out and transforming it into and conveniently using it as the cart whenever the cart is needed without additional components or lowering utilization of limited space. Particularly, the present invention is also directed to providing a vehicle luggage board to be used as a cart, in which cloth members are used as both side surfaces to minimize a total thickness of a luggage board and firmly and fixedly support a front plate and a rear plate so that the cart can be safely and conveniently used.

### CROSS-REFERENCE TO RELATED APPLICATION

This application claims priority to and the benefit of Korean Patent Application No. 10-2023-0161068, filed Nov. 20, 2023, the disclosure of which is incorporated herein by reference in its entirety.

### BACKGROUND

### 1. Field of the Invention

The present invention relates to a vehicle luggage board to be used as a cart, and more specifically, to a vehicle luggage board to be used as a cart, in which a luggage board used as a floor of a trunk is provided to be folded and used as a shopping cart having castors as necessary so that the luggage board is easily taken out, transformed into a cart, and conveniently used anytime and anywhere a cart is needed.

### 2. Discussion of Related Art

Generally, a cart may be provided in a vehicle to shop or carry simple items after moving to a market using the vehicle as in Patent Documents 1 to 3.

### (Patent Document 1) Korean Laid-open Patent No. 10-2023-0031068

This is related to a foldable cart to be loaded on a vehicle including a cart body in which an item is put and which is loaded on a vehicle, a leg of which a height is adjusted and which is rotated to be folded and unfolded, and a handle having a function of sterilizing and disinfecting the item accommodated in the cart body. Since the cart body in which the item (baggage) is accommodated may be loaded in a luggage room or trunk of the vehicle through a simple manipulation by a user, work of loading the purchased item on the vehicle can be easily performed, and the item accommodated in the cart body may be sterilized and disinfected using an ultraviolet light-emitting diode (UV LED) in a state in which the cart body is loaded on the vehicle.

### (Patent Document 2) Korean Laid-open Patent No. 10-2019-0138142

This is related to a shopping cart to be loaded on a vehicle and is directed to allowing a user to take out a shopping cart mounted in a trunk of a vehicle, shop for an item, mount the cart on the vehicle without additionally moving the item, move the cart, take the cart out, and then conveniently move the cart to its destination. That is, the shopping cart to be loaded on a vehicle includes a body of the shopping cart which may be laterally unfolded to be flat when entering a trunk, a cart leg which is folded as soon as it enters the trunk like a wheel of an ambulance stretcher, a wheel mounted on the leg, a layer which is a device capable of folding the cart leg, a handle mounted on the body to allow the cart to be pushed, a bottom floor wheel mounted on a bottom floor of the cart body to smoothly enter the trunk, and a carrying box provided in the cart to easily move the item in the cart. Accordingly, there is an effect that the user takes out the personal cart mounted in the trunk, performs shopping, and mounts the shopping cart in the trunk so that the user can conveniently perform the shopping without difficulty by quickly shopping and carrying the shopping cart home.

### (Patent Document 3) Korean Laid-open Patent No. 10-2016-0052132

This is related to a cart which has a smart function and is easily put in and taken out of a trunk of a vehicle. Accordingly, this provides a smart cart to be embedded in a vehicle, with which shopping may be conveniently performed, and a trunk may be automatically opened to easily load luggage using an immobilizer system used in an existing smart key when the cart has been moved to the vehicle of a user.

### RELATED ART

### Patent Documents

(Patent Document 1) Korean Laid-open Patent No. 10-2023-0031068 (Published date: Mar. 7, 2023)
(Patent Document 2) Korean Laid-open Patent No. 10-2019-0138142 (Published date: Dec. 12, 2019)
(Patent Document 3) Korean Laid-open Patent No. 10-2016-0052132 (Published date: May 12, 2016)

### SUMMARY OF THE INVENTION

However, such structures have following problems.

(1) A cart should be manufactured of separate components, rather than components basically mounted in a vehicle, and then mounted in the vehicle.

(2) Accordingly, space for storing the conventional cart is required, and utilization of limited space of a vehicle is lowered due to the space occupied by the cart as described above.

(3) Meanwhile, not only is a structure of the conventional cart complex, but a large cost is also required due to difficulty in manufacturing.

(4) In addition, since the cart is installed to be exposed to an interior such as trunk space and used as necessary, the aesthetics of the interior can be degraded when the cart is not used.

(5) In addition, the conventional cart cannot be provided in a vehicle in which space, such as trunk space, capable of accommodating the cart is not provided.

The present invention is disclosed in consideration of the above problems and is directed to providing a vehicle luggage board to be used as a cart in which a luggage board provided as a basic component in each vehicle and installed on a floor of a trunk is used and is transformed into and used as a cart as necessary, so that the luggage board is taken out and transformed into and conveniently used as the cart anytime when the cart is needed without additional components or lowering utilization of a limited space.

Particularly, the present invention is also directed to providing a vehicle luggage board to be used as a cart, in which cloth members are used as both side surfaces to minimize a total thickness of a luggage board and firmly and fixedly support a front plate and a rear plate so that the cart can be safely and conveniently used.

According to an aspect of the present invention, there is provided a vehicle luggage board to be used as a cart, which is divided into a base (100) and a front plate (200) and a rear plate (300) which are installed to be rotated about and assembled with both sides of the base (100), wherein accommodation grooves (110), which accommodate castors, are formed in both sides of a bottom surface of the base (100), the front plate (200) includes two castors (211), which are installed at one side of one surface of the front plate (200) and protrude from one edge of the front plate (200) to be accommodated in the accommodation grooves (110), a handle (210) which is installed at the other side and of which a length is adjusted outward from the front plate (200), and a first cloth member (220) of which one side is fixed to an edge portion adjacent to the castors (211) and the other side is fixedly in close contact with the front plate (200) or is fixed to or separated from an edge of the rear plate (300) rotated about the base (100), and the rear plate (300) includes a support (310), which includes two castors (311) which are installed at one side of one surface of the rear plate (300) and protrude toward the one edge of the front plate (200) to be accommodated in the accommodation grooves (110), and a second cloth member (320) of which one side is fixed to an edge portion of the rear plate (300) adjacent to the support (310) and the other side is fixedly in close contact with the rear plate (300) or is fixed to or separated from an edge of the front plate (200) rotated about the base (100).

Each of the front plate (200) and the rear plate (300) may include fixing bars (230, 330) which rotate in place at both side surfaces thereof, and the fixing bars (230, 330) may be forcibly fitted into two holes (120′, 120″) formed in side surfaces of the base (100) to maintain a state in which the front plate (200) and the rear plate (300) are perpendicularly folded with respect to the base (100) or a state in which the front plate (200), the rear plate (300), and the base (100) are horizontally spread.

In addition, the first cloth member (220) and the second cloth member (320) may be installed in close contact with the front plate (200) and the rear plate (300), respectively, using Velcros (221, 321) when not used in the cart and may be mounted on the rear plate (300) and the front plate (200), respectively, to form side surfaces when used in the cart.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a side view illustrating a vehicle, which shows a state in which a vehicle luggage board to be used as a cart is mounted according to the present invention;

FIG. 2 is a perspective view illustrating the vehicle luggage board to be used as a cart according to the present invention;

FIG. 3 is a perspective view illustrating a state in which the vehicle luggage board to be used as a cart is transformed into a cart according to the present invention;

FIG. 4 is an exploded perspective view illustrating components of the vehicle luggage board to be used as a cart according to the present invention;

FIG. 5 is a side view illustrating a state in which a front plate and a rear plate, on which cloth members are unfolded, are rotated on a base to assembly the cart according to the present invention;

FIG. 6 is a side view illustrating a state in which the front plate is fixed to the base and then the rear plate is rotated to be fixed thereto according to the present invention; and

FIG. 7 is a side view illustrating a state in which the front plate and the rear plate are fixed to the base and then side surfaces are formed using the cloth members.

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications substituting the exemplary embodiments at the time of filing of this application.

### [Structure of Vehicle Luggage Board to be Used as Cart]

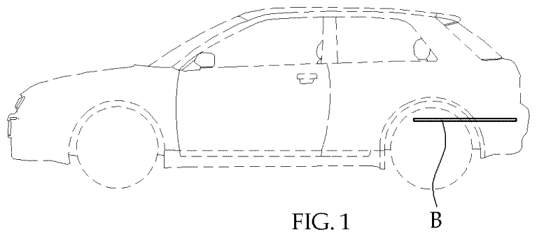

As illustrated in FIGS. 1 to 7, a vehicle luggage board B to be used as a cart according to the present invention includes a base 100 divided into a predetermined size and a front plate 200 and a rear plate 300 which are provided to be rotated toward each other about both sides of the base 100 and assembled with the base 100.

Particularly, the front plate 200 and the rear plate 300 include castors 211 and 311 which are stored in the base 100 when the front plate 200 and the rear plate 300 are unfolded to form one flat surface with the base 100, and the castors 211 and 311 protrude outward when the front plate 200 and the rear plate 300 are perpendicularly folded with respect to the base 100, and thus the luggage board B can be used as a cart.

In this case, the front plate 200 and the rear plate 300 are provided with a first cloth member 220 and a second cloth member 320, respectively, the first cloth member 220 and the second cloth member 320 are fixedly in contact with the plates when not used in the cart, the first cloth member 220 and the second cloth member 320 are fixed to facing plates and used as side surfaces when used in the cart, and items are put in the cart and conveniently transported.

In addition, the first cloth member 220 and the second cloth member 320 are provided to be fixed or separated in a Velcro type, so that everyone can easily and conveniently use the first cloth member 220 and the second cloth member 320.

Meanwhile, fixing bars 230 and 330 are mounted on the front plate 200 and the rear plate 300 such that one sides of the fixing bars 230 and 330 rotate in place, and holes 120′ and 120″ are formed in both sides of the base 100 such that the other sides of the fixing bars 230 and 330 are forcibly fitted into and assembled with the holes 120′ and 120″. Accordingly, when the fixing bars 230 and 330 are fixed to any one hole 120′, the front plate 200 and the rear plate 300 form one flat surface with the base 100, and when the fixing bars 230 and 330 are forcibly fitted into the other hole 120″, the front plate 200 and the rear plate 300 remain perpendicularly rotated with respect to the base 100.

Hereinafter, such a structure will be described in more detail with reference to the accompanying drawings. In the drawings, “B” denotes a luggage board according to the present invention, which may be mounted on a floor of a trunk and transformed into and used as the cart.

### A. Base

As illustrated in FIGS. 1 to 3, the luggage board B is divided into three pieces, and in this case, the base 100 is a portion divided at a central portion. In this case, the base 100 is preferably divided to have a size the same as or similar to those of the front plate 200 and the rear plate 300 which are provided to face each other and will be described below. In the drawings, an example of the luggage board B is equally trisected into the base 100, the front plate 200, and the rear plate 300.

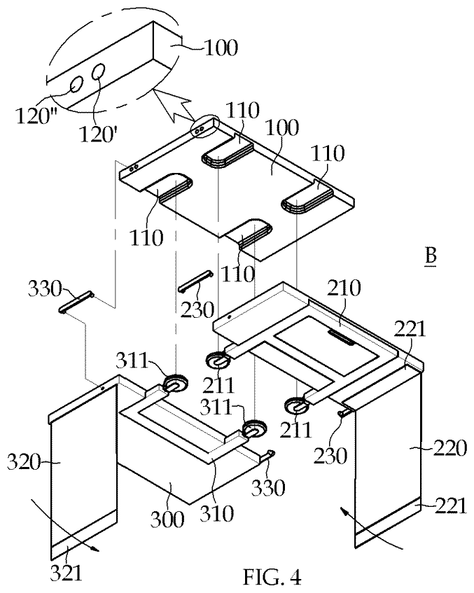

Meanwhile, as illustrated in FIGS. 4 to 7, accommodation grooves 110 for accommodating the castors and the holes 120′ and 120″ used for fixing the front plate 200 and the rear plate 300 are formed in the base 100.

### 1. Accommodation Groove

As illustrated in FIG. 4, the accommodation grooves 110 are formed by partially cutting portions of a bottom surface of the base 100 in a thickness direction. In this case, the accommodation grooves 110 are provided to accommodate the castors 211 and 311 formed on the front plate 200 and the rear plate 300, which will be described below, to prevent the castors 211 and 311 from being exposed to the outside so that a thickness of the luggage board B does not increase and the cart can be dragged. Accordingly, the accommodation grooves 110 are formed in edge portions on which the front plate 200 and the rear plate 300 are installed, and in the drawing, an example in which two accommodation grooves 110 are formed each side from both edges, that is, four accommodation grooves 110 are formed, is illustrated.

### 2. Hole

As illustrated in FIGS. 4, 5, and 7, the holes 120′ and 120″ are formed in portions of side surfaces of the base 100 which are adjacent to edges which are rotary centers of the front plate 200 and the rear plate 300 in a longitudinal direction of the side surfaces.

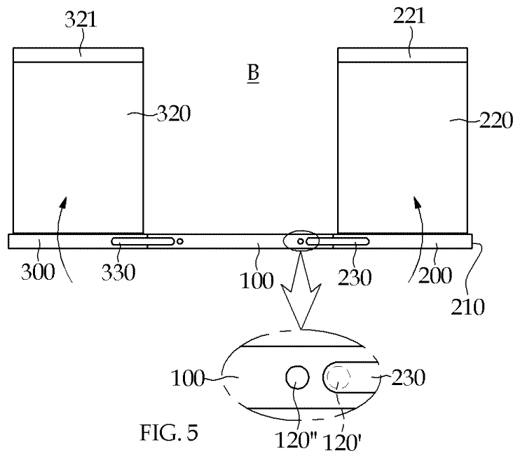

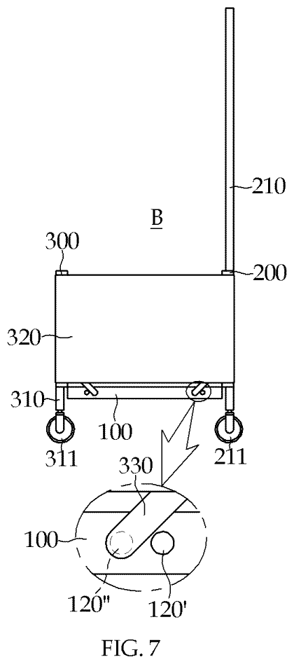

In this case, as illustrated in FIGS. 4, 5, and 7, as the fixing bars 230 and 330, which are mounted on the front plate 200 and the rear plate 300 such that one sides of the fixing bars 230 and 330 are rotated in place, are forcibly fitted into the holes 120′ and 120″, locations of the front plate 200 and the rear plate 300 are fixed. That is, as illustrated in FIG. 5, for example, in a state in which the front plate 200 is unfolded with respect to the base 100, the fixing bars 230 are forcibly fitted into the holes 120′ formed at outer sides so that the base 100 and the front plate 200 maintain one flat surface state. In addition, as illustrated in FIG. 7, in a state in which the front plate 200 is perpendicularly rotated about the base 100, the fixing bars 230 are rotated and forcibly fitted into the holes 120″ formed at inner sides so that the base 100 and the front plate 200 maintain a perpendicular state.

### B. Front Plate

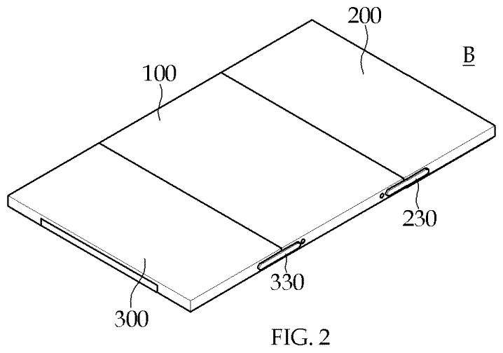

As illustrated in FIGS. 2 to 4, one edge of the front plate 200 is mounted on the base 100 to be rotated in place. In this case, it is preferable that the front plate 200 be mounted on the base 100 to be rotated in place using a hinge or pin, and the hinge or pin is preferably formed not to protrude from an upper surface used as a surface of the luggage board B so that the luggage board B can be used safely.

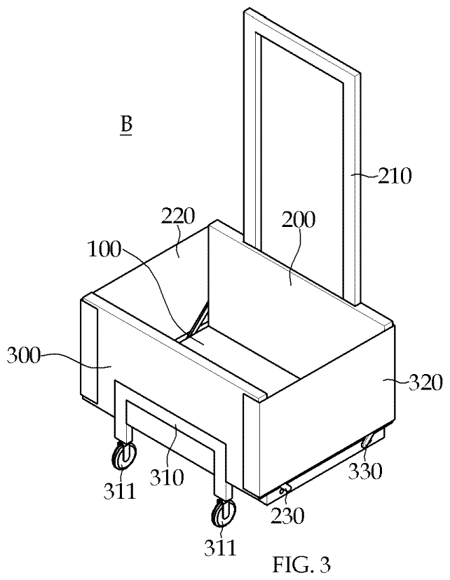

As illustrated in FIGS. 3 to 7, the front plate 200 includes a handle 210 and a first cloth member 220.

### 1. Handle

As illustrated in FIGS. 3 and 4, the handle 210 is mounted on one surface of the front plate 200. In this case, the handle 210 is mounted on a portion corresponding to an outer surface when the front plate 200 is rotated about the base 100.

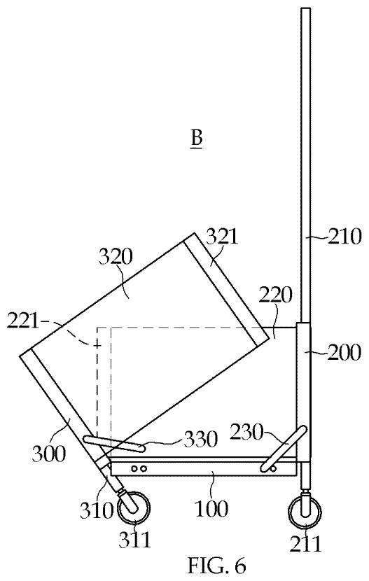

Meanwhile, as illustrated in FIGS. 4 to 7, the handle 210 is mounted such that the castors 211 protrude outward from the front plate 200 at one side of the handle 210, the castors 211 are accommodated in the accommodation grooves 110 when the front plate 200 is unfolded with respect to the base 100 as illustrated in FIGS. 4 and 5, and the castors 211 are withdrawn from the accommodation grooves 110 to serve as the castors when the front plate 200 is rotated about the base 100 as illustrated in FIGS. 6 and 7.

In addition, as illustrated in FIGS. 4 to 7, the handle 210 is provided such that a length of the handle 210 is adjusted by pulling the handle 210 outward from front the plate 200. General technology applied to a trunk, travel bag, or the like may be applied to the handle 210.

### 2. First Cloth Member

As illustrated in FIGS. 3 to 7, one side of the first cloth member 220 is fixed to the front plate 200, and the other side thereof is mounted on or separated from the front plate 200 or the rear plate 300 which will be described below.

In this case, as illustrated in FIGS. 2 to 4, the first cloth member 220 is installed to be fixed to any one edge of the base 100 adjacent to an edge of the front plate 200 rotatably supported by the base 100 and mounted on or separated from a portion of the other edge thereof to cover the handle 210. This is to allow the first cloth member 220 to cover the handle 210 and to remain fixed to the front plate 200 when the luggage board B according to the present invention is not used as the cart, and to allow the first cloth member 220 to be separated from the front plate 200 and rotated to be used as the side surface of the cart when the luggage board B according to the present invention is used as the cart.

In the exemplary embodiment of the present invention, as illustrated in FIGS. 3 and 4, the first cloth member 220 is preferably formed to be attached to the front plate 200 or the rear plate 300, which will be described below, using a Velcro 221 so that everyone can easily assemble and use the cart. In addition, the first cloth member 220 may be manufactured with waterproof cloth or waterproof nylon used where waterproof is required or waterproof polyester or cordura used for a bag or tent.

Meanwhile, as illustrated in FIGS. 4 to 7, as the fixing bars 230 are mounted at both sides of the front plate 200, the front plate 200 and the base 100 form one flat surface with the base 100, or the front plate 200 remains perpendicularly rotated about the base 100.

### Fixing Bar

As illustrated in FIGS. 4 and 5, one side of the fixing bar 230 is mounted on each side of the front plate 200, which is rotated about the base 100, to be rotated in place. In this case, the other side of the fixing bar 230 is provided to be forcibly fitted into any one of the two holes 120′ and 120″ to be assembled or separated therefrom.

In this case, the fixing bar 230 is manufactured to have a length such that the fixing bar 230 is forcibly fitted into the hole 120′ close thereto when the base 100 and the front plate 200 are unfolded to form one flat surface as illustrated in FIG. 5, the fixing bar 230 is rotated in place about the base 100 in a state in which the fixing bar 230 is not forcibly fitted into any hole as illustrated in FIG. 6, and the base 100 and the front plate 200 maintain a perpendicular state when the fixing bar 230 is forcibly fitted into the hole 120″ at the inner side as illustrated in FIG. 7.

### C. Rear Plate

As illustrated in FIGS. 2 to 4, the rear plate 300 is mounted to be rotated about the base 100 to face the front plate 200. In addition, coupling relationships between the fixing bars 330 and the holes 120′ and 120″, which maintain a rotated state as described above, and a function of the second cloth member 320 mounted to cover the rear plate 300 and forming the side surface when used in the cart are applied to the rear plate 300, and the rear plate 300 includes a Velcro 321 used to form the side surface. Since the function, the structure, and the operation are the same as those of the coupling relationship between the fixing bars 230 and the holes 120′ and 120″, the first cloth member 220, and the already described Velcro 221 which have been described when the front plate 200 was described, in this case, the detailed description thereof will be omitted.

Meanwhile, as illustrated in FIGS. 3 and 4, the rear plate 300 includes a support 310. In this case, the support 310 is installed to form one flat surface with the rear plate 300, and the support 310 is mounted such that the castors 311 protrude outward from the rear plate 300 at one side of the support 310. In this case, the castors 311 are accommodated in the accommodation grooves 110 when the rear plate 300 and the base 100 form one flat surface, and protrude downward from the base 100 to serve to roll when the rear plate 300 is rotated about the base 100.

In the present invention described above, when the luggage board is not used as the cart, the front plate and the rear plate are fixed at both sides of the base to form one flat surface and used as the luggage board spread on the floor of the trunk, and when the cart is needed, the luggage board is taken out and easily assembled and used as the cart at any time.

A vehicle luggage board to be used as a cart according to the present invention has the following effects.

(1) As a luggage board essentially mounted in a trunk of a vehicle is used as a cart, the number of additional components can be minimized, and the luggage board can be transformed into and conveniently used as the cart whenever necessary.

(2) In addition, a base, which is a central portion of the luggage board, and a front plate and a rear plate at both sides of the base are provided, and the front plate and the rear plate are perpendicularly stood up with respect to the base so that the cart can be easily assembled and conveniently used.

(3) In this case, since the front plate and the rear plate become one flat surface with the base and are used in the luggage board or become perpendicular to a surface of the base and are used in the cart according to positions at which ends of fixing bars installed to be rotated in place are assembled by being forcibly fitted into the base, it is convenient.

(4) Meanwhile, cloth members are provided such that one sides thereof are fixed to the front plate and the rear plate, and the other sides thereof are attached to the facing plates so that the cloth members are used as side surfaces, thereby minimizing an increase in thickness of the luggage board and allowing items to be conveniently put therein and carried.

(5) The luggage board can not only be easily manufactured due to a simple structure thereof, and but is also easily manufactured with a small manufacturing cost so that the luggage board can be conveniently used.

What is claimed is:

1. A vehicle luggage board to be used as a cart, which is divided into:
a base (100); and
a front plate (200) and a rear plate (300) which are installed to be rotated about and assembled with both sides of the base (100),
wherein accommodation grooves (110), which accommodate castors, are formed in both sides of a bottom surface of the base (100),
the front plate (200) includes two castors (211), which are installed at one side of one surface of the front plate (200) and protrude from one edge of the front plate (200) to be accommodated in the accommodation grooves (110), a handle (210) which is installed at the other side and of which a length is adjusted outward from the front plate (200), and a first cloth member (220) of which one side is fixed to an edge portion adjacent to the castors (211) and the other side is fixedly in close contact with the front plate (200) or is fixed to or separated from an edge of the rear plate (300) rotated about the base (100), and
the rear plate (300) includes a support (310), which includes two castors (311) which are installed at one side of one surface of the rear plate (300) and protrude toward the one edge of the front plate (200) to be accommodated in the accommodation grooves (110), and a second cloth member (320) of which one side is fixed to an edge portion of the rear plate (300) adjacent to the support (310) and the other side is fixedly in close contact with the rear plate (300) or is fixed to or separated from an edge of the front plate (200) rotated about the base (100).

2. The vehicle luggage board of claim 1, wherein:
each of the front plate (200) and the rear plate (300) includes fixing bars (230, 330) which rotate in place at both side surfaces thereof; and
the fixing bars (230, 330) are forcibly fitted into two holes (120′, 120″) formed in side surfaces of the base (100) to maintain a state in which the front plate (200) and the rear plate (300) are perpendicularly folded with respect to the base (100) or a state in which the front plate (200), the rear plate (300), and the base (100) are horizontally spread.

3. The vehicle luggage board of claim 1, wherein the first cloth member (220) and the second cloth member (320) are:
installed in close contact with the front plate (200) and the rear plate (300), respectively, using Velcros (221, 321) when not used in the cart and
mounted on the rear plate (300) and the front plate (200), respectively, to form side surfaces when used in the cart.

4. The vehicle luggage board of claim 2, wherein the first cloth member (220) and the second cloth member (320) are:
installed in close contact with the front plate (200) and the rear plate (300), respectively, using Velcros (221, 321) when not used in the cart and
mounted on the rear plate (300) and the front plate (200), respectively, to form side surfaces when used in the cart.
